(19) United States
(12) Patent Application Publication
(10) Pub. No.: US 2020/0109358 A1
(43) Pub. Date: Apr. 9, 2020

(54) DETERGENT SINGLE DOSE PACKS WITH FRUCTOSE/GLUCOSE SOLVENT BLENDS FOR ENZYME STABILITY AND METHODS OF PRODUCING THE SAME

(71) Applicant: Henkel IP & Holding GmbH, Duesseldorf (DE)

(72) Inventor: Daniel T. Piorkowski, Fairfield, CT (US)

(73) Assignee: Henkel IP & Holding GmbH, Duesseldorf (DE)

(21) Appl. No.: 16/151,488

(22) Filed: Oct. 4, 2018

(51) Int. Cl. C11D 17/04; C11D 3/43; C11D 3/22; C11D 3/386

(52) U.S. Cl. CPC C11D 17/043; C11D 3/43; C11D 1/83; C11D 3/38618; C11D 3/221

(57) ABSTRACT

A single dose pack exhibiting improved enzyme stability and methods for producing the same are provided. The single dose pack includes a container composed of a water-soluble film and a wash composition encapsulated within the container. The wash composition includes a detergent surfactant, an enzyme, and a solvent blend. The enzyme is present in an amount of about 0.01 wt. % to about 0.5 wt. % active enzyme, based on the overall weight of the wash composition. The solvent blend includes water; a non-aqueous solvent selected from the group consisting of propylene glycol, glycerin, polyethylene glycol, and mixtures of two or more thereof; and a saccharide system including fructose and glucose. The saccharide system is present in an amount of about 1 wt. % to about 30 wt. %, based on the overall weight of the wash composition.

### TECHNICAL FIELD

The technical field relates to detergent packaged in single dose packs and methods of producing the same, and more particularly relates to single dose packs with fructose/glucose solvent blends for improved enzyme stability and methods of producing the same.

### BACKGROUND

Detergent packaged in single (unit) dose packs is available for a variety of washing activities, such as clothes laundering and dish washing. The single dose pack provides a pre-measured quantity of detergent that is easy to carry and convenient to use. The single dose pack minimizes over-dosage of detergent and has proven popular with consumers.

Many single dose packs include a wash composition that is encapsulated within a film, where the wash composition includes detergent, solvents, and other components useful for cleaning, such as enzymes. Water is one solvent often utilized in single dose packs. Propylene glycol, polyethylene glycol, and glycerin are further, non-aqueous solvents that are often utilized in single dose packs.

In order to be effective for cleaning, enzymes need to remain in their “active” form, that is, to retain their ability to act as a catalyst to bring about a specific biochemical reaction for cleaning. It has been observed, however, that enzymes used in single dose packs that contain only water and/or the non-aqueous solvents mentioned above tend to lose their activity over time, for example during storage or transportation to the consumer. For example, enzymatic activity may be reduced by as much as half over a four-week period, when included in such solvent systems.

Accordingly, it is desirable to provide single dose packs that maintain their enzymatic activity for extended periods of time, and methods of producing such single dose packs. More particularly, it is desirable to provide improved solvent systems for such single dose packs that are able to stabilize the included enzymes and preserve their activity. Furthermore, other desirable features and characteristics will become apparent from the subsequent detailed description and the appended claims, taken in conjunction with the foregoing technical field and background.

### BRIEF SUMMARY

The inventors herein have surprisingly discovered that wash composition solvent systems that include blends of fructose and glucose exhibit a significantly greater enzyme stability as compared to wash compositions whose solvents systems include no saccharides, or whose solvent systems include only fructose. The inventive wash compositions of the present disclosure have been shown to actually increase the active enzyme content over a period of time, such as several weeks, whereas comparative wash compositions were demonstrated to lose almost half of their enzyme activity.

Accordingly, the present disclosure provides single dose pack exhibiting improved enzyme stability and methods for producing the same. In one embodiment, a single dose pack includes a container composed of a water-soluble film and a wash composition encapsulated within the container. The wash composition includes a detergent surfactant, an enzyme, and a solvent blend. The enzyme is present in an amount of about 0.01 wt. % to about 0.5 wt. % active enzyme, based on the overall weight of the wash composition. The solvent blend includes water; a non-aqueous solvent selected from the group consisting of propylene glycol, glycerin, polyethylene glycol, and mixtures of two or more thereof; and a saccharide system including fructose and glucose. The saccharide system is present in an amount of about 1 wt. % to about 30 wt. %, based on the overall weight of the wash composition. The single dose pack may be configured for laundry or dishwashing applications.

In another embodiment, a single dose pack includes a container composed of a water-soluble film and a wash composition encapsulated within the container. The wash composition includes a detergent surfactant, an enzyme, and a solvent blend. The enzyme is present in an amount of about 0.01 wt. % to about 0.5 wt. % active enzyme, based on the overall weight of the wash composition. The solvent blend consists of water; a non-aqueous solvent selected from the group consisting of propylene glycol, glycerin, polyethylene glycol, and mixtures of two or more thereof; and a saccharide system consisting of fructose and glucose. The saccharide system is present in an amount of about 1 wt. % to about 30 wt. %, based on the overall weight of the wash composition. Again, the single dose pack may be configured for laundry or dishwashing applications.

In yet another embodiment, a single dose pack configured for use in a laundry washing machine or a dishwashing machine includes a container composed of a water-soluble film and a wash composition encapsulated within the container. The wash composition includes a detergent surfactant. The detergent surfactant is selected from the group consisting of: a nonionic surfactant, an anionic surfactant, a cationic surfactant, and mixtures of two or more thereof, and the detergent surfactant is present in an amount of about 5 wt. % to about 70 wt. %, based on the overall weight of the wash composition. The wash composition further includes an enzyme. The enzyme is selected from protease, amylase, mannanase, pectinase, cellulase, and mixtures of two or more thereof, and the enzyme is present in an amount of about 0.05 wt. % to about 0.4 wt. % active enzyme, based on the overall weight of the wash composition. The enzyme maintains a consistent enzymatic activity over a period of time. Still further, the wash composition includes a solvent blend. The solvent blend consists of water, a non-aqueous solvent, and a saccharide system. The water is present in an amount of about 5 wt. % to about 25 wt. %, based on the overall weight of the wash composition. The non-aqueous solvent is selected from the group consisting of propylene glycol, glycerin, polyethylene glycol, and mixtures of two or more thereof. The non-aqueous solvent is present in an amount of about 1 wt. % to about 20 wt. %, based on the overall weight of the wash composition. The saccharide system consists of fructose and glucose. The saccharide system has a fructose : glucose weight ratio of about 1:3 to about 3:1, and the saccharide system is present in an amount of about 5 wt. % to about 25 wt. %, based on the overall weight of the wash composition.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the single dose pack, or the method for producing or using the same. Furthermore, there is no intention to be bound by any theory presented in the preceding background or the following detailed description.

The term “about” as used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated.

The present disclosure generally relates to single (unit) dose wash compositions, contained within single dose packs, that achieve a significantly improved enzyme activity over a period of time (such as during storage or transportation) through the use of a solvent system that includes a blend of saccharides, namely fructose and glucose. In some embodiments, the solvent system may further include water and other non-aqueous solvents, such as polyethylene glycol, propylene glycol, and/or glycerin. In some embodiments, the enzymes included in the wash composition may include protease, amylase, mannanase, pectinase, and/or cellulase. Greater detail regarding the individual components of the inventive single dose packs in accordance with the various embodiments of the present disclosure is provided below.

### Container/Water—Soluble Film

In general, single dose packs in accordance with the present disclosure are formed by encapsulating a wash composition within a container, where the container includes a water-soluble film. The container seals the wash composition in one or more chambers. The film of container is water soluble such that the film will completely dissolve when an exterior of the film is exposed to water, such as in a washing machine typically used for laundry or dishes. When the film dissolves, the container is ruptured and the contents, including the wash composition, are released. As used herein, “water soluble” means at least 2 grams of the solute (the film in one example) will dissolve in 5 liters of solvent (water in one example,) for a solubility of at least 0.4 grams per liter (g/l), at a temperature of 25 degrees Celsius (° C.) unless otherwise specified. Suitable films for packaging are completely soluble in water at temperatures of about 5° C. or greater.

The film is desirably strong, flexible, shock resistant, and non-tacky during storage at both high and low temperatures and high and low humidities. In an exemplary embodiment, the film is initially formed from polyvinyl acetate, and at least a portion of the acetate functional groups are hydrolyzed to produce alcohol groups. Therefore, the film includes polyvinyl alcohol (PVOH), and may include a higher concentration of PVOH than polyvinyl acetate. Such films are commercially available with various levels of hydrolysis, and thus various concentrations of PVOH, and in an exemplary embodiment the film initially has about 85 percent of the acetate groups hydrolyzed to alcohol groups. Some of the acetate groups may further hydrolyze in use, so the final concentration of alcohol groups may be higher than the concentration at the time of packaging. The film may have a thickness of from about 25 to about 200 microns (μm), or from about 45 to about 100 μm, or from about 70 to about 90 μm in various embodiments. The film may include alternate materials in some embodiments, such as methyl hydroxy propyl cellulose and polyethylene oxide, but the film is water soluble in all embodiments.

The wash composition is positioned within the container, and the container is sealed to encase and enclose the wash composition. The wash composition is typically in direct contact with the film of the container within the single dose pack. The film of the container is sealable by heat, heat and water, ultrasonic methods, or other techniques, and one or more sealing techniques may be used to enclose the wash composition within the container.

In an exemplary embodiment, the wash composition is liquid when encapsulated within the container. The liquid wash composition may have a viscosity of from about 50 to about 2,500 centipoise, or from about 100 to about 500 centipoise in different embodiments, where “viscosity,” as used herein, means the viscosity measured by a rotational viscometer at a temperature of 25 degrees Celsius (° C.). The liquid form facilitates rapid delivery and dispersion of the wash composition once the container ruptures, and this rapid dispersion can aid cleaning.

In an exemplary embodiment, the single dose pack is sized to provide a desired quantity of wash composition for one load of laundry or one batch of dishes in a dishwasher. The single dose pack may also be sized for a fraction of a desired quantity, such as one half of a load of laundry, so a user can adjust the amount of detergent added without having to split a single dose pack. In an exemplary embodiment, the single dose pack (including the container and the wash composition) has a weight of from about 15 to about 75 grams. In alternate embodiments, the single dose pack has a weight from about 15 to about 40 grams, or from about 17 to about 30 grams.

The film remains structurally sound and intact prior to use of the single dose pack, where the single dose pack is immersed in a large quantity of water in use. A “large” quantity of water is at least about 100 times the weight of the single dose pack. For example, a single dose pack having a weight of from about 5 to about 50 grams may be immersed in from about 5 to about 50 liters of water in use. As used herein, “structurally sound” means the container and the film do not rupture or leak under typical storage conditions, such as about 0.5 to about 1.5 atmospheres of pressure, temperatures of about −10 to about 35° C., and a relative humidity of about 1 to about 80% for a period of at least 1 week. Structurally sound also means the container and the film are not tacky or sticky to the touch.

### Wash Composition—Detergent Surfactant

A plurality of components is combined to form a wash composition, where the wash composition is typically prepared prior to encapsulation within the container. The plurality of components includes at least the enzyme and the solvent system, as mentioned above. The wash composition may have a pH of about 5.5 to about 9.5, such as about 6.5 to about 8.5. The plurality of components also generally includes at least one detergent surfactant, as well as various optional additives, as will be discussed in greater detail below.

The was composition may include a detergent surfactant that is selected from the group consisting of: a nonionic surfactant, an anionic surfactant, a cationic surfactant, and mixtures of two or more thereof. Thus, in some embodiments, the wash composition may include an ionic detergent surfactant, where the ionic detergent surfactant is formulated for laundry in an exemplary embodiment. The ionic detergent surfactant may include one or more surfactants, including cationic and/or anionic surfactants, in various embodiments.

Suitable ionic detergent surfactants that are anionic include soaps which contain sulfate or sulfonate groups, including those with alkali metal ions as cations. Usable soaps include alkali metal salts of saturated or unsaturated fatty acids with 12 to 18 carbon (C) atoms. Such fatty acids may also be used in incompletely neutralized form. Usable ionic detergent surfactants of the sulfate type include the salts of sulfuric acid semi esters of fatty alcohols with 12 to 18 C atoms, and/or alcohol ethoxysulfates. Usable ionic detergent surfactants of the sulfonate type include alkane sulfonates with 12 to 18 C atoms and olefin sulfonates with 12 to 18 C atoms, such as those that arise from the reaction of corresponding mono-olefins with sulfur trioxide, alpha-sulfofatty acid esters such as those that arise from the sulfonation of fatty acid methyl or ethyl esters, and lauryl ether sulfates.

Suitable ionic detergent surfactants that are cationic may include textile-softening substances of the general formula X, XI, or XII as illustrated below:

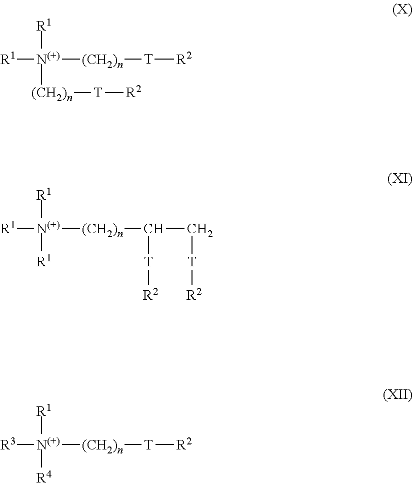

in which each R¹ group is mutually independently selected from among C₁₋₆ alkyl, alkenyl or hydroxyalkyl groups; each R² group is mutually independently selected from among C₈₋₂₈ alkyl or alkenyl groups; R³=R¹ or (CH₂)ₙ-T-R²; R⁴=R¹ or R² or (CH₂)ₙ-T-R²; T=—CH₂—, —O—CO—, or —CO—O—, and n is an integer from 0 to 5. The ionic detergent surfactants that are cationic may include conventional anions of a nature and number required for charge balancing. Alternatively, the ionic detergent surfactant may include anionic detergent surfactants that may function to balance the charges with the cationic detergent surfactants. In some embodiments, ionic detergent surfactants that are cations may include hydroxyalkyltrialkylammonium compounds, such as C₁₂₋₁₈ alkyl(hydroxyethyl)dimethyl ammonium compounds, and may include the halides thereof, such as chlorides or other halides. The ionic detergent surfactants that are cations may be especially useful for compositions intended for treating textiles.

In some embodiments, the anionic surfactant is a polyethoxylated alcohol sulfate, such as those sold under the trade name CALFOAM® 303 (Pilot Chemical Company, California). Such materials, also known as alkyl ether sulfates (AES) or alkyl polyethoxylate sulfates, are those which correspond to the following formula (XIII):

R′—O—(C2H4O)n-SO3M′ (XIII)

wherein R′ is a C8-C20 alkyl group, n is from 1 to 20, and M′ is a salt-forming cation, preferably, R′ is C10-C18 alkyl, n is from 1 to 15, and M′ is sodium, potassium, ammonium, alkylammonium, or alkanolammonium. In another embodiment, R′ is a C12-C16 alkyl, n is from 1 to 6 and M′ is sodium. In another embodiment, the alkyl ether sulfate is sodium lauryl ether sulphate (SLES).

In some embodiments, the anionic surfactant can be linear alkylbenzene sulfonic acid (LAS) or a salt thereof, alkyl ethoxylated sulphate, alkyl propoxy sulphate, alkyl sulphate, or a mixture thereof. Linear alkylbenzenesulfonate (LAS) is a water soluble salt of a linear alkyl benzene sulfonate having between 8 and 22 carbon atoms of the linear alkyl group. The salt can be an alkali metal salt, or an ammonium, alkylammonium, or alkanolammonium salt. In one embodiment, the LAS includes an alkali metal salt of C₁₀-C₁₆ alkyl benzene sulfonic acids, such as C₁₁-C₁₄ alkyl benzene sulfonic acids.

However, in other embodiments, the liquid compositions are substantially free of LAS. In other embodiments, the liquid compositions are substantially free of a sulfate surfactant.

Suitable nonionic detergent surfactants include alkyl glycosides and ethoxylation and/or propoxylation products of alkyl glycosides or linear or branched alcohols in each case having 12 to 18 C atoms in the alkyl moiety and 3 to 20, or 4 to 10, alkyl ether groups. Corresponding ethoxylation and/or propoxylation products of N-alkylamines, vicinal diols, fatty acid esters and fatty acid amides, which correspond to the alkyl moiety in the stated long-chain alcohol derivatives, may furthermore be used. Alkylphenols having 5 to 12 C atoms may also be used in the alkyl moiety of the above described long-chain alcohol derivatives.

Examples of nonionic surfactants suitable for the present invention include, but are not limited to, polyalkoxylated alkanolamides, polyoxyalkylene alkyl ethers, polyoxyalkylene alkylphenyl ethers, polyoxyalkylene sorbitan fatty acid esters, polyoxyalkylene sorbitol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, amine oxide surfactants, alkoxylated fatty alcohols, or a mixture thereof. In some embodiments, the nonionic surfactant is alcohol ethoxylate (AE), alcohol propoxylate, or a mixture thereof. In other embodiments, the nonionic surfactant is AE.

The AE may be primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles, or from 3 to 8 moles of ethylene oxide per mole of alcohol.

Exemplary AEs are the condensation products of aliphatic C₈-C₂₀, preferably C₈-C₁₆, primary or secondary, linear or branched chain alcohols with ethylene oxide. In some embodiments, the alcohol ethoxylates contain 1 to 20, or 3 to 8 ethylene oxide groups, and may optionally be end-capped by a hydroxylated alkyl group.

In one embodiment, the AE has Formula (XIV):

R₂ —(—O—C₂H₄—)ₘ—OH (XIV)

wherein R₂ is a hydrocarbyl group having 8 to 16 carbon atoms, 8 to 14 carbon atoms, 8 to 12 carbon atoms, or 8 to 10 carbon atoms; and m is from 1 to 20, or 3 to 8.

The hydrocarbyl group may be linear or branched, and saturated or unsaturated. In some embodiments, R₂ is a linear or branched C₈-C₁₆ alkyl or a linear group or branched C₈-C₁₆ alkenyl group. Preferably, R₂ is a linear or branched C₈-C₁₆ alkyl, C₈-C₁₄ alkyl, or C₈-C₁₀ alkyl group. In case (e.g., commercially available materials) where materials contain a range of carbon chain lengths, these carbon numbers represent an average. The alcohol may be derived from natural or synthetic feedstock. In one embodiment, the alcohol feedstock is coconut, containing predominantly C₁₂-C₁₄ alcohol, and oxo C₁₂-C₁₅ alcohols.

One suitable AE is Tomadol® 25-7 (available from Air Product). Other suitable AEs include Genapol® C200 (available from Clariant), which is a coco alcohol having an average degree of ethoxylation of 20.

Detergent surfactants may be present in the wash composition at a concentration of from about 1 to about 70 weight percent, or from about 5 to about 70 weight percent, or from about 1 to about 60 weight percent, or from about 5 to about 60 weight percent, or from about 10 to about 70 weight percent, or from about 10 to about 60 weight percent in various embodiments, based on the total weight of the wash composition. In other embodiment, detergent surfactants may be present in the wash composition at a concentration of from about 1 to about 10 weight percent, from about 10 to about 20 weight percent, from about 20 to about 30 weight percent, from about 30 to about 40 weight percent, from about 40 to about 50 weight percent, or from about 50 to about 60 weight percent, or from about 60 to about 70 weight percent, again based on the total weight of the wash composition.

### Wash Composition—Enzyme

Possible enzymes that may be in the wash composition contemplated herein include one or more of a protease, amylase, mannanase, lipase, cutinase, carbohydrase, cellulase, pectinase, arabinase, galactanase, xylanase, oxidase, (e.g., a laccase), and/or peroxidase, but others are also possible. Of the foregoing enzymes, protease, amylase, mannanase, pectinase, and cellulase are preferred in some embodiments of the present disclosure, and protease is particularly preferred in an embodiment. In general, the properties of the selected enzyme(s) should be compatible with the selected wash composition, (i.e., pH-optimum, compatibility with other enzymatic and non-enzymatic ingredients, etc.). As initially noted above, the wash composition may have a pH of about 5.5 to about 9.5, such as about 6.5 to about 8.5. The detergent enzyme(s) may be included in the wash composition by adding separate additives containing one or more enzymes, or by adding a combined additive including all the enzymes that are added to the wash composition. Suitable enzyme additives are solutions that are about 10% active, such as about 7% to about 13% active. In other embodiments, enzymes can be added in a powder form, such as in a granular form.

The enzyme may be present in the wash composition in effective amounts, such as from about 0.01 to about 0.5 weight percent active enzyme (for example, about 0.1 to about 5 weight percent of a 10% active enzyme solution), or from about 0.05 to about 0.4 weight percent active enzyme (for example, about 0.5 to about 4 weight percent of a 10% active enzyme solution), or from about 0.1 to about 0.3 weight percent active enzyme (for example, about 1 to about 3 weight percent of a 10% active enzyme solution), based on the total weight of the wash composition, in various embodiments. In other embodiments, the enzyme is present within the wash composition in an amount of from about 0.01 to about 0.1 weight percent active enzyme (for example, about 0.1 to about 1 weight percent of a 10% active enzyme solution), about 0.1 to about 0.2 weight percent active enzyme (for example, about 1 to about 2 weight percent of a 10% active enzyme solution), about 0.2 to about 0.3 weight percent active enzyme (for example, about 2 to about 3 weight percent of a 10% active enzyme solution), about 0.3 to about 0.4 weight percent active enzyme (for example, about 3 to about 4 weight percent of a 10% active enzyme solution), or about 0.4 to about 0.5 weight percent active enzyme (for example, about 4 to about 5 weight percent of a 10% active enzyme solution).

### Wash Composition—Solvent Blend

The wash composition of the present disclosure, in some embodiments, includes a solvent blend of water, a saccharide system including both fructose and glucose, and a non-aqueous solvent that is different from the saccharide system (i.e., as used herein, the term “non-aqueous solvent” refers to non-aqueous solvents that are not saccharides). In other embodiments, the wash composition includes a solvent blend that consists of water, a saccharide system consisting of fructose and glucose, and a non-aqueous solvent that is different from the saccharide system. Such solvent blends have been demonstrated to achieve excellent enzyme stability, as will be detailed below.

Accordingly, water is included in the wash composition at a concentration of up to about 25% total water, such as from about 5% to about 25% total water, from about 8% to about 25% total water, from about 5% to about 20% total water, from about 8% to about 20% total water, from about 5% to about 15% total water, or from about 8% to about 15% total water, by weight of the overall wash composition. In other embodiments, water is included in the wash composition at a concentration of about 5% to about 8%, about 8% to about 12%, about 12% to about 20%, or about 20% to about 25% total water, by weight of the overall wash composition. Water may be added to the wash composition directly or as a component of other ingredients, or directly and as a component of other ingredients.

In addition to the water, the wash composition may include non-aqueous solvent(s). For example, non-aqueous solvents that may be included in the wash composition are glycerin, propylene glycol, and 4C+ compounds. The term “4C+ compound” refers to one or more of: polyethylene glycol; polypropylene glycol; polyethylene glycol esters such as polyethylene glycol stearate, propylene glycol laurate, and/or propylene glycol palmitate; methyl ester ethoxylate; diethylene glycol; dipropylene glycol; sorbitol; tetramethylene glycol; butylene glycol; pentanediol; hexylene glycol; heptylene glycol; octylene glycol; 2-methyl, 1,3 propanediol; xylitol; mannitol; erythritol; dulcitol; inositol; adonitol; triethylene glycol; polypropylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methylsulfate; ethylene oxide/propylene oxide copolymers with a number average molecular weight of 3,500 Daltons or less; and ethoxylated fatty acids. In some embodiments, preferred non-aqueous solvents for use in the present wash composition include glycerin, propylene glycol, and polyethylene glycol, with propylene glycol being particularly preferred in an embodiment.

The non-aqueous solvents may be included in the wash composition in an amount of from about 1% to about 20%, such as from about 5% to about 20%, or about 10% to about 20%, or about 1% to about 15%, or about 5% to about 15%, or about 10% to about 15%, by weight of the overall wash composition. In other embodiments, the non-aqueous solvents may be included in the wash composition in an amount of from about 1% to about 5%, or about 5% to about 10%, or about 10% to about 15%, or about 15% to about 20%, by weight of the overall wash composition.

In addition to water and non-aqueous solvent, the wash composition may further include a saccharide system of fructose and glucose. In some embodiments, a weight ratio of fructose to glucose in the saccharide system may be from about 1:5 to about 5:1, such as about 1:4 to about 4:1, or about 1:3 to about 3:1, or about 1:2 to about 2:1, or about 1:1.5 to about 1.5 to 1, or about 1:1. In other embodiments, a weight ratio of fructose to glucose in the saccharide system may be from about 1:5 to about 3:1, or about 1:5 to about 2:1, or about 1:5 to about 1:1, or about 1:3 to about 5:1, or about 1:2 to about 5:1, or about 1:1 to about 5:1. The saccharide system may be included in the wash composition in an amount of about 1% to about 30%, or about 5% to about 25%, or about 10% to about 25%, or about 5% to about 20%, or about 10% to about 20%, by weight of the overall wash compositions. In other embodiments, the saccharide system may be included in the wash composition in an amount of about 1% to about 5%, about 5% to about 10%, about 10% to about 15%, about 15% to about 20%, about 20% to about 25%, or about 25% to about 30%, by weight of the overall wash composition.

In some embodiments, the wash composition may have a weight ratio of saccharide system to active enzyme of about 3000:1 to about 10:5, such as about 2000:1 to about 10:3, or about 1000:1 to about 10:1. In other embodiments, a weight ratio of saccharide system to active enzyme may be about 2000:1 to about 1000:1, or about 1000:1 to about 500:1, or about 500:1 to about 10:1, or about 10:1 to about 10:3.

In some embodiments, high-fructose corn syrup (HFCS) may be employed as the saccharide system. HFCS typically refers to a blend of approximately 20% to 35% water and approximately 65% to 80% saccharide. HFCS is sold commercially using numerical indicators for the weight-% content of fructose. For example, HFCS 42 typically refers to a blend of about 29% water, about 29% glucose, and about 42% fructose; and, HFCS 55 typically refers to a blend of about 23% water, 22% glucose, and about 55% fructose. HFCS 65 and HFCS 90 are also known in the art. Unless otherwise stated, HFCS used herein refers to a wet blend which contains water, as it is supplied from HFCS manufacturers. However, it should be understood that dry or essentially dry hybrid of monosaccharides (e.g. HFCS), wherein water has been removed partially or completely, can also be used. If HFCS is not employed, other carbohydrate syrups that may be used include light corn syrup (fructose) and glucose syrup, blended together according to a desired ratio, as discussed above. In some embodiments, HFCS 55 is employed as the saccharide system.

Optionally, in some embodiments, further carbohydrates may be included in the solvent blend. Other suitable carbohydrates may alternatively or additionally include sucrose, xylitol, sorbitol, mannitol, erythritol, dulcitol, inositol, adonitol, tagatose, trehalo se, galactose, rhamnose, cyclodextrin, maltodextrin, dextran, sucrose, ribulose, threose, arabinose, xylose, lyxose, allose, altrose, mannose, idose, lactose, maltose, invert sugar, isotrehalose, neotrehalose, palatinose or isomaltulose, erythrose, deoxyribose, gulose, idose, talose, erythrulose, xylulose, psicose, turanose, cellobiose, amylopectin, glucosamine, mannosamine, fucose, glucuronic acid, gluconic acid, glucono-lactone, abequose, galactosamine, beet oligosaccharides, isomalto-oligosaccharides, xylo-oligosaccharides, gentio-oligoscaccharides, sorbose, nigero-oligosaccharides, palatinose oligosaccharides, fucose, fractooligosaccharides, maltotetraol, maltotriol, malto-oligosaccharides, lactulose, melibiose, raffinose, rhamnose, ribose, coupling sugars, or soybean oligosaccharides, and a mixture thereof.

### Wash Composition—Optional Components

Several other components may optionally be added to and included in the wash composition, including but not limited to preservatives, anti-redeposition agents, optical brighteners, foam inhibitors, chelators, buttering agents, dye transfer inhibitors, soil release agents, water softeners, and other components. A partial, non-exclusive list of additional components (not illustrated) that may be added to and included in the wash composition include electrolytes, pH regulators, graying inhibitors, anti-crease components, bleach agents, colorants, scents, and processing aids.

The wash composition includes one or more organic or inorganic preservatives. Suitable organic or inorganic acid-based preservatives include, but are not limited to, sorbic acid and benzoic acid. The organic or inorganic acid-based preservative may alternatively be provided in salt-of-acid form, for example sodium sorbate, sodium benzoate, potassium sorbate, or potassium benzoate. The organic or inorganic acid-based preservative may be included in the wash composition in an amount of about 0.01% to about 0.50%, such as about 0.02% to about 0.25%, or from about 0.05% to about 0.20%, by weight of the overall wash composition.

One or more anti-redeposition agents may also be optionally included in the wash composition. Anti-redeposition agents include polymers with a soil detachment capacity, which are also known as “soil repellents” due to their ability to provide a soil-repelling finish on the treated surface, such as a fiber. Anti-redeposition agents include polymers with a soil detachment capacity. One example in regard to polyesters includes copolyesters prepared from dicarboxylic acids, such as adipic acid, phthalic acid or terephthalic acid. In an exemplary embodiment, an anti-redeposition agents includes polyesters with a soil detachment capacity that include those compounds which, in formal terms, are obtainable by esterifying two monomer moieties, the first monomer being a dicarboxylic acid HOOC-Ph-COOH and the second monomer a diol HO-(CHR¹¹—)ₐOH, which may also be present as a polymeric diol H—(O—(CHR¹¹—)ₐ)_{b}OH. Ph here means an ortho-, meta- or para-phenylene residue that may bear 1 to 4 substituents selected from alkyl residues with 1 to 22 C atoms, sulfonic acid groups, carboxyl groups and mixtures thereof. R¹¹ means hydrogen or an alkyl residue with 1 to 22 C atoms and mixtures thereof “a” means a number from 2 to 6 and “b” means a number from 1 to 300. The polyesters obtainable therefrom may contain not only monomer diol units —O—(CHR¹¹—)ₐO— but also polymer diol units —(O—(CHR¹¹—)ₐ)_{b}O—. The molar ratio of monomer diol units to polymer diol units may amount to from about 100:1 to about 1:100, or from about 10:1 to about 1:10 in another embodiment. In the polymer diol units, the degree of polymerization “b” may be in the range of from about 4 to about 200, or from about 12 to about 140 in an alternate embodiment. The average molecular weight of the polyesters with a soil detachment capacity may be in the range of from about 250 to about 100,000, or from about 500 to about 50,000 in an alternate embodiment. The acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid and mixtures thereof. Where the acid groups thereof are not part of the ester bond in the polymer, they may be present in salt form, such as an alkali metal or ammonium salt. Exemplary embodiments include sodium and potassium salts.

If desired, instead of the monomer HOOC-Ph-COOH, the polyester with a soil detachment capacity (the anti-redeposition agent) may include small proportions, such as no more than about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR¹¹—)ₐOH include those in which R¹¹ is hydrogen and “a” is a number of from about 2 to about 6, and in another embodiment includes those in which “a” has the value of 2 and R¹¹ is selected from hydrogen and alkyl residues with 1 to 10 C atoms, or where R¹¹ is selected from hydrogen and alkyl residues with 1 to 3 C atoms in another embodiment. Examples of diol components are ethylene glycol, 1,2-propylene glycol, 1,3-propylene glycol, 1,4-butanediol, 1,5-pentanediol, 1,6-hexanediol, 1,8-octanediol, 1,2-decanediol, 1,2-dodecanediol and neopentyl glycol. The polymeric diols include polyethylene glycol with an average molar mass in the range from about 1000 to about 6000. If desired, these polyesters may also be end group-terminated, with end groups that may be alkyl groups with 1 to 22 C atoms or esters of monocarboxylic acids. The end groups attached via ester bonds may be based on alkyl, alkenyl and aryl monocarboxylic acids with 5 to 32 C atoms, or with 5 to 18 C atoms in another embodiment. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, which may bear 1 to 5 substituents having a total of up to 25 C atoms, or 1 to 12 C atoms in another embodiment, for example tert-butylbenzoic acid. The end groups may also be based on hydroxymonocarboxylic acids with 5 to 22 C atoms, which for example include hydroxyvaleric acid, hydroxycaproic acid, ricinoleic acid, the hydrogenation product thereof, hydroxystearic acid, and ortho-, meta- and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e. their degree of oligomerization, may be in the range of from 1 to 50, or in the range of from 1 to 10 in another embodiment. In an exemplary embodiment, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, are used alone or in combination with cellulose derivatives. The anti-redeposition agent is present in the wash composition at an amount of from about 0 to about 3 weight percent, or an amount of from about 0 to about 2 weight percent, or an amount of from about 0 to about 1 weight percent, based on the total weight of the wash composition, in various embodiments.

Optical brighteners may optionally be included in the wash composition. Optical brighteners adsorb ultraviolet and/or violet light and re-transmit it as visible light, typically a visible blue light. Optical brighteners include, but are not limited to, derivatives of diaminostilbene disulfonic acid or the alkali metal salts thereof. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-stated optical brighteners may also be used. Optical brighteners may be present in the wash composition at an amount of from about 0 to about 1 weight percent in some embodiments, but in other embodiments optical brighteners are present in an amount of from about 0.01 to about 0.5 weight percent, or an amount of from about 0.05 to about 0.3 weight percent, or an amount of from 0.005 to about 5 weight percent, based on the total weight of the wash composition.

Foam inhibitors may also optionally be included in the wash composition. Suitable foam inhibitors include, but are not limited to, soaps of natural or synthetic origin, which include an elevated proportion of C₁₈-C₂₄ fatty acids. Suitable non-surfactant foam inhibitors are, for example, organopolysiloxanes and mixtures thereof with microfine, optionally silanized silica as well as paraffins, waxes, microcrystalline waxes and mixtures thereof with silanized silica or bis-fatty acid alkylenediamides. Mixtures of different foam inhibitors may also be used, for example mixtures of silicones, paraffins or waxes. In an exemplary embodiment, mixtures of paraffins and bistearylethylenediamide may be used. The wash composition may include the foam inhibitor at an amount of from about 0 to about 5 weight percent, but in other embodiments the foam inhibitor may be present at an amount of from about 0.05 to about 3 weight percent, or an amount of from about 0.5 to about 2 weight percent, based on the total weight of the wash composition.

Chelators bind and remove calcium, magnesium, or other metals from water, and may optionally be included in the wash composition. Many compounds can be used as water softeners, including but not limited to ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, iminodisuccinic acid (IDS), or other chelating agents. Chelators may be present in the wash composition at an amount of from about 0 to about 5 weight percent in an exemplary embodiment, but in alternate embodiments the chelators are present at an amount of from about 0.01 to about 3 weight percent or an amount of from about 0.02 to about 1 weight percent, based on the total weight of the wash composition.

Bittering agents may optionally be added to hinder accidental ingestion of the single dose pack or the wash composition. Bittering agents are compositions that taste bad, so children or others are discouraged from accidental ingestion. Exemplary bittering agents include denatonium benzoate, aloin, and others. Bittering agents may be present in the wash composition at an amount of from about 0 to about 1 weight percent, or an amount of from about 0 to about 0.5 weight percent, or an amount of from about 0 to about 0.1 weight percent in various embodiments, based on the total weight of the wash composition.

The components of the wash composition are combined and mixed together with a mixer. Once mixed, the wash composition is encapsulated in the container, as described above. The components of the wash composition may all be mixed at one time, or different components may be pre-mixed and then combined. A wide variety of mixers may be used in alternate embodiments, such as an agitator, an in-line mixer, a ribbon blender, an emulsifier, and others. The wash composition is placed in one or more chambers of the container. Then, the film of the container is sealed with a sealer, where the sealer may utilize heat, water, ultrasonic techniques, water and heat, pressure, or other techniques for sealing the container and forming the single dose pack.

Another exemplary embodiment is also directed to the use of a single dose pack as described above in a cleaning process such as laundry and/or hard surface cleaning. In particular, an embodiment is directed to the use of a single dose pack in laundering of textile and fabrics, such as house hold laundry washing and industrial laundry washing. A further exemplary embodiment is directed to the use of a single dose pack in hard surface cleaning such as automated dish washing (ADW), car washing, and the cleaning of industrial surfaces.

The fabrics and/or garments subjected to a washing, cleaning or textile care processes contemplated herein may be conventional washable laundry, such as household laundry. In some embodiments, the major part of the laundry is garments and fabrics, including but not limited to knits, woven fabrics, denims, non-woven fabrics, felts, yarns, and toweling. The fabrics may be cellulose based such as natural cellulosics, including cotton, flax, linen, jute, ramie, sisal or coir or manmade cellulosics (e.g., originating from wood pulp) including viscose/rayon, ramie, cellulose acetate fibers (tricell), lyocell or blends thereof The fabrics may also be non-cellulose based such as natural polyamides including wool, camel, cashmere, mohair, rabbit, and silk, or the fabric may be a synthetic polymer such as nylon, aramid, polyester, acrylic, polypropylene and spandex/elastin, or blends of any of the above-mentioned products. Examples of blends are blends of cotton and/or rayon/viscose with one or more companion material such as wool, synthetic fibers (e.g., polyamide fibers, acrylic fibers, polyester fibers, polyvinyl alcohol fibers, polyvinyl chloride fibers, polyurethane fibers, polyurea fibers, aramid fibers), and cellulose-containing fibers (e.g., rayon/viscose, ramie, flax, linen, jute, cellulose acetate fibers, lyocell).

In one embodiment, the fabrics and/or garments are added to a washing machine, and the single dose pack is also added to the washing machine before wash water is added. In an alternate embodiment, the single dose pack may be added to an automatic detergent addition system of a washing machine, where the contents of the single dose pack are added to the wash water with the fabrics and/or garments after the washing process has begun. In yet another embodiment, the single dose pack is manually added to the fabrics and/or garments with the wash water after the washing process has started. The film dissolves and releases the wash composition into the aqueous wash water. The film is dissolved and washes out of the washing machine with the excess wash water, so there is nothing to collect from the fabrics and/or garments after the wash cycle. The fabrics and/or garments are laundered with the wash water and the contents of the single dose pack. The fabrics and/or garments may then be dried and processed as normal.

In an alternate embodiment, the single dose pack is added to a detergent charging system for an automatic dish washing machine. The detergent charging system opens and releases the single dose pack to the wash water and a main compartment of the dish washing machine at a designated point in the wash cycle.

### ILLUSTRATIVE EXAMPLE

The present disclosure is now illustrated by the following non-limiting example. It should be noted that various changes and modifications can be applied to the following example and processes without departing from the scope of this disclosure, which is defined in the appended claims. Therefore, it should be noted that the following example should be interpreted as illustrative only and not limiting in any sense.

A wash composition Example was prepared in accordance with the present disclosure including several detergent surfactants totaling to about 54% by weight of the wash composition, several enzymes in 10% active enzyme solutions totaling to about 2.5% by weight of the wash composition (i.e., totaling to about 0.25% by weight active enzyme), and a solvent blend of water, propylene glycol, and a saccharide system, together totaling to about 29% by weight of the wash composition (added water at about 8%, propylene glycol at about 5%, and the saccharide system of glucose and fructose (HFCS 55) at about 16%). As described above, HFCS 55 has the following composition: a blend of water (about 23%), glucose (about 34%), and fructose (about 42%). This Example, including all of the other additional ingredients to 100%, is set forth below in, TABLE 1.

TABLE 1

| | Activity | Example | Comparison |
|---|---|---|---|
| Ingredient | % | Wt. % | Wt. % |
| C12-C15 Alcohol Ethoxylate 7EO | 99.9 | 23.1 | 23.1 |
| Propylene Glycol | 100 | 5.0 | 5.0 |
| Monoethanolamine | 100 | 1.8 | 1.8 |
| Added Water | 100 | 8.0 | 8.0 |
| Linear Alkylbenzenesulfonate | 95 | 5.0 | 5.0 |
| Coconut Oil Fatty Acid | 100 | 4.0 | 4.0 |
| Sodium C12-C14 Alcohol | 60 | 26.0 | 26.0 |
| Ethoxysulfate 3EO | | | |
| Bitrex | 25 | 0.05 | 0.05 |
| Tinopal CBS-X | 100 | 0.3 | 0.3 |
| Cleaning Polymer | 80 | 4.0 | 4.0 |
| Anti-Redeposition Polymer | 35 | 1.5 | 1.5 |
| Iminodisuccinic Acid | 33 | 0.9 | 0.9 |
| Coronase 48UL | 10 | 1.5 | 1.5 |
| Marmanase Enzyme Solution | 10 | 0.6 | 0.6 |
| Amylase Enzyme Solution | 10 | 0.4 | 0.4 |
| Fragrance | 100 | 1.6 | 1.6 |
| High Fructose Corn Syrup 55 | 77 | 16.3 | 0.0 |
| Light Corn Syrup | 77 | 0.0 | 16.3 |
| Colorant | 100 | 0.03 | 0.03 |
| Total | | 100.0 | 100.0 |

As shown in TABLE 1, also provided is a Comparison, which has the same composition as the Example, except that the HFCS has been substituted for a like amount of light corn syrup (which includes about 77% fructose and about 23% water, by weight). Both the Example and the Comparison formulations have a total water content of about 21%, by weight.

Two mixtures of each of the Example and Comparison were prepared, for a total of four wash compositions. Two single dose packs were prepared from each wash composition, for a total of eight single dose packs. The protease enzyme activity level of each pack was measured at the time of preparation of each pack, in units of KIPU/Liter. The eight single dose packs were then aged in storage at 37° C. for a period of four weeks. At the end of the four weeks, the protease enzyme activity level of each pack was again measured. A percentage of protease enzyme remaining for each pack was thus determined by comparing the initial protease enzyme activity reading to the aged protease enzyme activity reading. TABLE 2, below, presents the results of this testing.

TABLE 2

| | | | Change in |
|---|---|---|---|
| | Initial | 4-Week | Enzyme |
| Wash Composition | KIPU/L | KIPU/L | Activity |
| Example-Mixture 1, Pack 1 | 1.525 | 1.875 | 115% |
| Example-Mixture 1, Pack 2 | 1.542 | 1.892 | 115% |
| Example-Mixture 2, Pack 1 | 1.793 | 1.809 | 106% |
| Example-Mixture 2, Pack 2 | 1.792 | 1.797 | 106% |
| Comparison-Mixture 1, | 2.211 | 1.250 | 56% |
| Pack 1 | | | |
| Comparison-Mixture 1, | 2.247 | 1.245 | 56% |
| Pack 2 | | | |
| Comparison-Mixture 2, | 1.960 | 1.256 | 64% |
| Pack 1 | | | |
| Comparison-Mixture 2, | 1.981 | 1.233 | 64% |
| Pack 2 | | | |

As can be seen in TABLE 2, the Comparison packs all lost between about 36% and about 44% of protease enzyme activity after four weeks of storage, whereas the Example packs all maintained their protease enzyme activity after the same storage period and under the same storage conditions. (The measured 115% and 106% changes in activity are within the measurement error of the enzyme measuring protocol, and thus these values are assumed to be 100%.) Thus, the present Illustrative Example demonstrates that solvent blends having a saccharide system of glucose and fructose have significantly better protease enzyme stability than solvent blends not having both saccharides, e.g., fructose only.

As such, the present disclosure has provided single dose wash compositions, contained within single dose packs, that achieve a significantly improved protease enzyme activity over a period of time (such as during storage or transportation) through the use of a solvent system that includes a blend of saccharides, namely fructose and glucose. As demonstrated, the inventive wash compositions of the present disclosure have been shown to maintain a consistent enzyme activity (i.e., enzymatic activity loss is no more than 5%) over a period of time, such as several weeks (e.g., 4 weeks), whereas comparative wash compositions were demonstrated to lose almost half of their enzyme activity.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A single dose pack comprising:
a container composed of a water-soluble film; and
a wash composition encapsulated within the container, wherein the wash composition comprises:
1) a detergent surfactant,
2) an enzyme, wherein the enzyme is present in an amount of about 0.01 wt. % to about 0.5 wt. % active enzyme, based on the overall weight of the wash composition, and
3) a solvent blend comprising:
a) water,
b) a non-aqueous solvent selected from the group consisting of propylene glycol, glycerin, polyethylene glycol, and mixtures of two or more thereof, and
c) a saccharide system comprising fructose and glucose, wherein the saccharide system is present in an amount of about 1 wt. % to about 30 wt. %, based on the overall weight of the wash composition.

2. The single dose pack of claim 1, wherein the enzyme is present in an amount of about 0.05 wt. % to about 0.4 wt. % active enzyme, based on the overall weight of the wash composition.

3. The single dose pack of claim 2, wherein the enzyme is present in an amount of about 0.1 wt. % to about 0.3 wt. % active enzyme, based on the overall weight of the wash composition.

4. The single dose pack of claim 1, wherein the saccharide system is present in an amount of about 5 wt. % to about 25 wt. %, based on the overall weight of the wash composition.

5. The single dose pack of claim 4, wherein the saccharide system is present in an amount of about 10 wt. % to about 20 wt. %, based on the overall weight of the wash composition.

6. The single dose pack of claim 1, wherein the saccharide system has a fructose: glucose weight ratio of about 1:5 to about 5:1.

7. The single dose pack of claim 6, wherein the saccharide system has a fructose: glucose weight ratio of about 1:3 to about 3:1.

8. The single dose pack of claim 1, wherein the enzyme is selected from protease, amylase, mannanase, pectinase, cellulase, and mixtures of two or more thereof.

9. The single dose pack of claim 8, wherein the enzyme comprises protease.

10. The single dose pack of claim 1, wherein the enzyme maintains a consistent enzymatic activity over a period of time.

11. The single dose pack of claim 1, wherein the water is present in an amount of about 5 wt. % to about 25 wt. %, based on the overall weight of the wash composition.

12. The single dose pack of claim 1, wherein the non-aqueous solvent is present in an amount of about 1 wt. % to about 20 wt. %, based on the overall weight of the wash composition.

13. The single dose pack of claim 1, wherein the non-aqueous solvent comprises propylene glycol.

14. The single dose pack of claim 1, wherein the detergent surfactant is present in an amount of about 5 wt. % to about 70 wt. %, based on the overall weight of the wash composition.

15. The single dose pack of claim 1, wherein the wash composition further comprises one or more additional components selected from the group consisting of: a preservative, an anti-redeposition agent, an optical brightener, a foam inhibitor, a chelator, a buttering agent, a dye transfer inhibitor, a soil release agent, a water softener, an electrolyte, a pH regulator, a graying inhibitor, an anti-crease component, a bleach agent, a colorant, a scent, and a processing aid.

16. The single dose pack of claim 1, wherein the single dose pack is configured for use in a laundry washing machine or a dishwashing machine.

17. A single dose pack comprising:
a container composed of a water-soluble film; and
a wash composition encapsulated within the container, wherein the wash composition comprises:
1) a detergent surfactant,
2) an enzyme, wherein the enzyme is present in an amount of about 0.01 wt. % to about 0.5 wt. % active enzyme, based on the overall weight of the wash composition, and
3) a solvent blend consisting of:
a) water,
b) a non-aqueous solvent selected from the group consisting of propylene glycol, glycerin, polyethylene glycol, and mixtures of two or more thereof, and
c) a saccharide system comprising fructose and glucose, wherein the saccharide system is present in an amount of about 1 wt. % to about 30 wt. %, based on the overall weight of the wash composition.

18. The single dose pack of claim 17, wherein the enzyme is present in an amount of about 0.1 wt. % to about 0.3 wt. % active enzyme, based on the overall weight of the wash composition, wherein the saccharide system is present in an amount of about 10 wt. % to about 20 wt. %, based on the overall weight of the wash composition, and wherein the saccharide system has a fructose : glucose weight ratio of about 1:3 to about 3:1.

19. The single dose pack of claim 17, wherein the enzyme is selected from protease, amylase, mannanase, pectinase, cellulase, and mixtures of two or more thereof, and wherein the enzyme maintains a consistent enzymatic activity over a period of time.

20. A single dose pack configured for use in a laundry washing machine or a dishwashing machine, comprising:
a container composed of a water-soluble film; and
a wash composition encapsulated within the container, wherein the wash composition comprises:
1) a detergent surfactant, wherein the detergent surfactant is selected from the group consisting of: a nonionic surfactant, an anionic surfactant, a cationic surfactant, and mixtures of two or more thereof, and wherein the detergent surfactant is present in an amount of about 5 wt. % to about 70 wt. %, based on the overall weight of the wash composition,
2) an enzyme, wherein the enzyme is selected from protease, amylase, mannanase, pectinase, cellulase, and mixtures of two or more thereof, and wherein the enzyme is present in an amount of about 0.05 wt. % to about 0.4 wt. % active enzyme, based on the overall weight of the wash composition, and wherein the enzyme maintains a consistent enzymatic activity over a period of time, and
3) a solvent blend consisting of:
a) water, wherein the water is present in an amount of about 5 wt. % to about 25 wt. %, based on the overall weight of the wash composition,
b) a non-aqueous solvent selected from the group consisting of propylene glycol, glycerin, polyethylene glycol, and mixtures of two or more thereof, wherein the non-aqueous solvent is present in an amount of about 1 wt. % to about 20 wt. %, based on the overall weight of the wash composition, and
c) a saccharide system consisting of fructose and glucose, wherein the saccharide system has a fructose:glucose weight ratio of about 1:3 to about 3:1 and wherein the saccharide system is present in an amount of about 5 wt. % to about 25 wt. %, based on the overall weight of the wash composition.
